(19) United States
(12) Patent Application Publication
(10) Pub. No.: US 2003/0121999 A1
(43) Pub. Date: Jul. 3, 2003

(54) Fuel injection valve

(76) Inventor: Michael Huebel, Gerlingen (DE)

Correspondence Address: KENYON & KENYON, ONE BROADWAY, NEW YORK, NY, 10004, US

(21) Appl. No.: 10/182,586

(22) PCT Filed: Nov. 30, 2001
(86) PCT No.: PCT/DE01/04508

(30) Foreign Application Priority Data
Dec. 5, 2000 (DE) 100 60 289.4

(51) Int. Cl. B05B 1/30

(52) U.S. Cl. 239/585.1

(57) ABSTRACT

A fuel injection valve (1) for fuel injection systems of internal combustion engines comprises a valve needle (3) and a valve closure element (4), in working engagement therewith, that coacts with a valve seating surface (6) arranged in a valve seat element (5) to form a sealing seat; and multiple spray discharge openings (7) downstream from the sealing seat. Spray discharge of the fuel from at least one spray discharge opening (7) can be switched off at least temporarily, and the spray discharge of fuel from a particular spray discharge opening (7) is switched off by local vaporization of fuel, by way of a respective local heating element (44) that is arranged upstream of the respective spray discharge opening (7) on a surface (43) delimiting the flow path.

### BACKGROUND OF THE INVENTION

The invention proceeds from a fuel injection valve according to the species defined in the main claim.

Fuel injection valves having multiple spray discharge openings are known. They possess, downstream from a sealing seat formed from a valve needle and a valve seating surface, multiple spray discharge openings, usually embodied as orifices, through which fuel is sprayed when the valve needle lifts off.

German Patent 32 28 079 discloses a multiple-orifice fuel injection valve in which the number of spray discharge openings that are opened is varied during the spray discharge operation. The use of a hollow valve needle and a second valve needle guided therein results in the formation of two sealing seats operating independently of one another. Opening of the fuel injection valve is controlled by the fuel pressure that is present. Firstly the hollow valve needle lifts off from its sealing seat and opens up some of the spray discharge openings, which are arranged on a first hole circle on the conically shaped downstream end of the fuel injection valve. After the preliminary injection volume has been discharged, the second valve needle lifts off and opens further spray discharge openings that are arranged on a second hole circle having a smaller diameter than the first hole circle. Until shortly before the end pf the spray discharge operation, the fuel pressure remains constant and both valve needles are lifted off from their respective sealing seats. Toward the end of the spray discharge operation, the fuel pressure decreases and the two valve needles return to their starting positions under spring force. Firstly the hollow needle closes off some of the spray discharge orifices and then the inner valve needle follows as the pressure decreases further.

A further fuel injection valve having a two-stage spray discharge characteristic is known from DE 31 20 044 C2. Similarly to the fuel injection valve cited above, here the fuel pressure is used as the opening force. The fuel injection valve has a first valve needle that is embodied, with a blind hole that is closed at the downstream end, as a hollow needle in whose interior the second valve needle is guided. At the beginning of the spray discharge operation, the hollow needle opens the fuel injection valve by being moved in the downstream direction by the fuel pressure that is present, thus sliding an annular groove, impinged on by fuel pressure, over the inflow end of the spray discharge openings. Introduced into the blind hole at the downstream end of the hollow needle is a sealing seat, downstream from which spray discharge openings are arranged. As the hollow needle moves in the downstream direction, the second valve needle is held by a spring in sealing contact on the sealing seat until any further movement is prevented by a mechanical stop. The hollow needle can continue to shift in the downstream direction, and as a result the second valve needle lifts off from its sealing seat and opens a second group of spray discharge openings. The closing operation proceeds in reverse order as a result of the decrease in fuel pressure.

Both of the fuel injection valves described have the disadvantage that they have only one permanently established opening and closing profile. Variability as a function of parameters of the operating state of the internal combustion engine is therefore not possible. Adjustments to the spray discharge pattern at the beginning and end of the spray discharge operation can be only a compromise, since decoupled adjustment of the two operations is not possible with a system that operates mechanically or hydro mechanically.

The purely hydro mechanical construction is also a disadvantage. It requires a plurality of components whose interaction demands high-precision machining. Production costs and the rejection rate are therefore high. In addition to the high costs for production of the individual parts, assembly of the fuel injection valve also must be performed in a plurality of steps, thus once again increasing both costs and the defect rate.

It is difficult to check the fuel injection valves in terms of functionality, which can be monitored only when the fuel injection valve is in operation. The complexity for a hydraulic test is considerable, and thus entails additional cost.

The mechanical complexity is disadvantageous in operation as well. There is a great deal of wear on the many moving parts, and the large masses that must be accelerated have a disadvantageous effect on response behavior and positioning velocity. If entire valve groups must be replaced as a result of wear, customers once again incur high costs.

### ADVANTAGES OF THE INVENTION

The fuel injection valve according to the present invention having the features of the main claim is, in contrast, usable in variable fashion. Activation and deactivation of individual spray discharge openings or groups of spray discharge openings is accomplished by way of electrical heating elements. Coupling to the fuel pressure in the fuel injection valve is not necessary. The number of spray discharge openings that are open can be influenced during the entire spray discharge operation. A different characteristic can thus be used especially at the beginning and the end of the discharge. The use of an electrical system permits control by way of a characteristics diagram that implements the optimum spray discharge geometry in accordance with the operating states of the internal combustion engine.

The reduction in moving parts is additionally advantageous. Only one valve needle is required, so that costly machining of coaxially configured sealing seats is eliminated. The simple construction of the valve needle itself also has a cost-reducing effect.

The elimination of moving parts also greatly decreases the moving mass. Opening and closing of the spray discharge openings is accomplished electrically. As a result of this, the response time of the system is considerably decreased and high switching frequencies can be used, so that one or more spray discharge openings can be opened and closed several times during one spray discharge operation.

The features set forth in the dependent claims make possible advantageous developments of the fuel injection valve described herein.

The triggering of multiple electrical circuits in order to energize the heating elements makes it possible, in contrast to mechanical approaches, to configure more than two spray discharge patterns. The added complexity for such a system is limited to the additional conductors for making contact to the heating elements.

The use of an electrical system is also positive in terms of quality assurance. A functional check of the switching functionality of the fuel injection valves can now be performed electrically, by mounting a test plug connector on the fuel injection valve. Such methods have proven successful in practice due to their short test times and high test accuracy.

Also advantageous is the use of an inflow disk on which the heating elements are mounted. This simplifies the implementation of variants. The use of geometrically identical inflow disks having different electrical parameters not only is associated with low development outlay, but also is easy to implement for production.

Application of the heating elements using thin-film technology is advantageous in terms of achieving short switching times. The associated reduction in the mass that must be heated improves switching time and thus increases the attainable switching frequency.

### DRAWINGS

An exemplified embodiment is depicted in simplified fashion in the drawings, and will be explained in more detail in the description below. In the drawings:

FIG. 1 is a schematic partial section through an exemplified embodiment of a fuel injection valve according to the present invention.

FIG. 2 is a schematic partial section, in area II of FIG. 1, through the exemplified embodiment of the fuel injection valve according to the present invention.

FIG. 3 is a schematic section along line III-III in FIG. 2.

FIG. 4 is a schematic section, in area IV of FIG. 2, through a fuel injection valve according to the present invention when the heating element is not energized.

FIG. 5 is a schematic section, in area IV of FIG. 2, through a fuel injection valve according to the present invention when the heating element is energized.

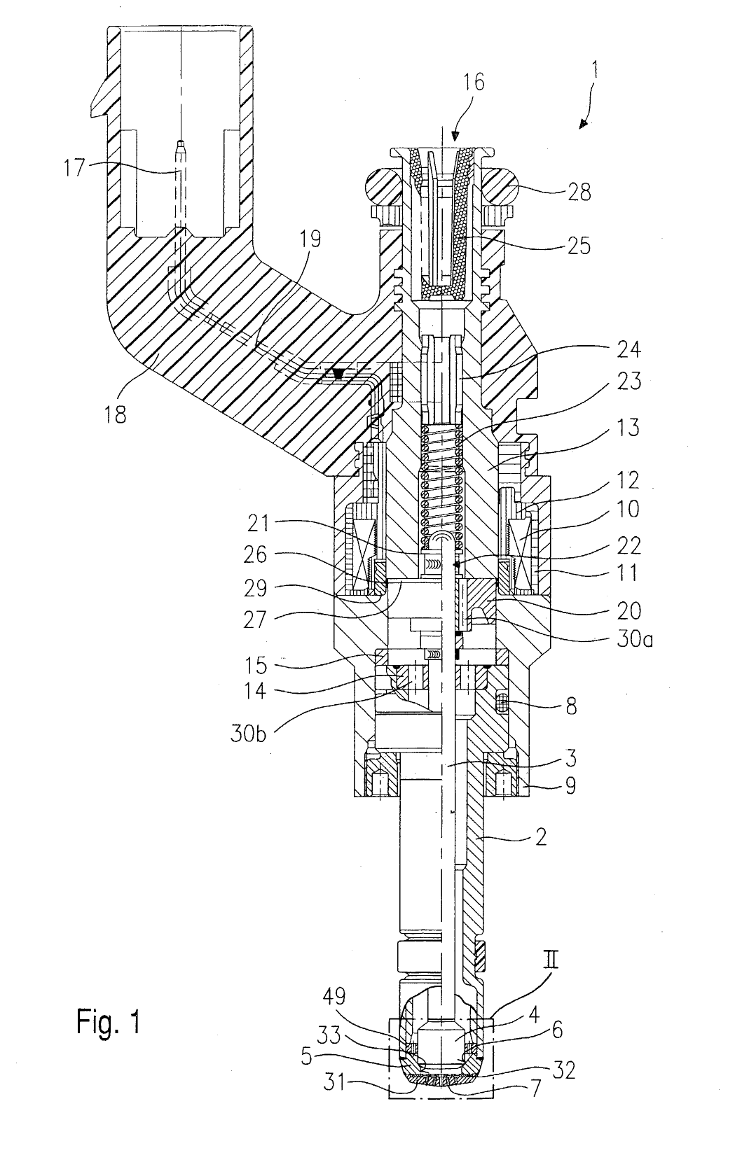

### DESCRIPTION OF THE EXEMPLARY EMBODIMENTS

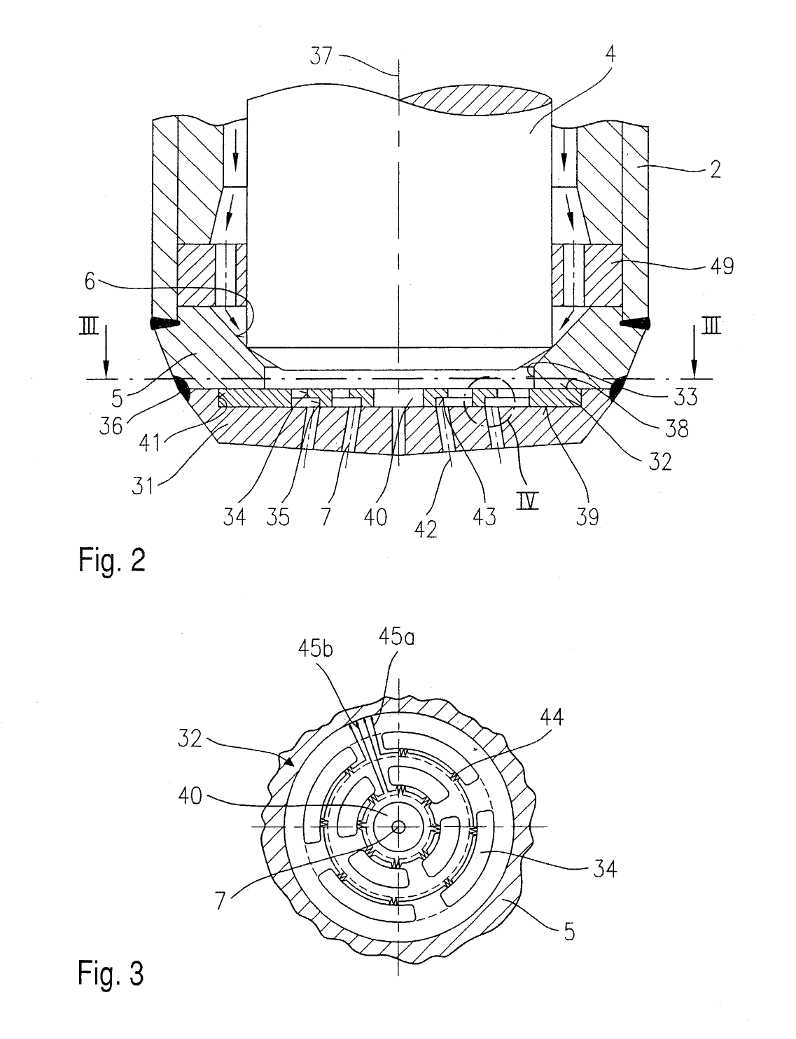

Before a detailed description is given of an exemplified embodiment of a fuel injection valve 1 according to the present invention with reference to FIGS. 2 through 5, fuel injection valve 1 according to the present invention will first, for better comprehension of the invention, be explained briefly in an overall presentation in terms of its essential constituents.

Fuel injection valve 1 is embodied in the form of a fuel injection valve 1 for fuel injection systems of mixture-compressing, spark-ignited internal combustion engines. Fuel injection valve 1 is suitable in particular for direct injection of fuel into a combustion chamber (not depicted) of an internal combustion engine.

Fuel injection valve 1 comprises a nozzle body 2 in which a valve needle 3 is arranged. Valve needle 3 is in working engagement with a valve closure element 4 which coacts with a valve seating surface 6, arranged on a valve seat element 5, to form a sealing seat. In the exemplified embodiment, fuel injection valve 1 is an electromagnetically actuated fuel injection valve 1 that possesses multiple spray discharge openings 7. Nozzle body 2 is sealed by a seal 8 with respect to an external pole 9 of a magnet coil 10. Magnet coil 10 is encapsulated in a coil housing 11 and wound onto a coil support 12 that rests on an internal pole 13 of magnet coil 10. Internal pole 13 and external pole 9 are separated from one another by a gap 26, and are supported on a connecting component 29. Magnet coil 10 is energized, via a conductor 19, by an electrical current that can be conveyed via an electrical plug contact 17. Plug contact 17 is surrounded by a plastic sheath 18 that can be injection-molded onto internal pole 13.

Valve needle 3 is guided in a valve needle guide 14 of diskshaped configuration. A further needle guide 49 at the spray discharge end is also provided. An adjusting disk 15, which serves to adjust the valve needle stroke, is paired with valve needle guide 14. Located on the upstream side of adjusting disk 15 is an armature 20. The latter is joined nonpositively, via a flange 21, to valve needle 3, which is joined to flange 21 by way of a weld seam 22. Braced against flange 21 is a return spring 23 which, in the present configuration of fuel injection valve 1, is preloaded by a sleeve 24 pushed into internal pole 13.

Fuel conduits 30a, 30b extend in valve needle guide 14 and in armature 20. A filter element 25 is arranged in a central fuel inlet 16. Fuel injection valve 1 is sealed by way of a seal 28 with respect to a fuel line (not depicted).

When fuel injection valve 1 is in the idle state, armature 20 is impinged upon opposite to its linear stroke direction by return spring 23, via flange 21 on valve needle 3, so that valve closure element 4 is held in sealing contact against valve seating surface 6. Upon energization of magnet coil 10, the latter establishes a magnetic field that moves armature 20 in the linear stroke direction against the spring force of return spring 23, the linear stroke being defined by a working gap 27 present between internal pole 13 and armature 20. Armature 20 entrains flange 21 that is welded to valve needle 3, and thus valve needle 3 as well, in the linear stroke direction. Valve closure element 4 that is in working engagement with valve needle 3 lifts off from valve seating surface 6, and fuel flows past valve closure element 4 into a passthrough opening 33 of valve seat element 5 and on through recesses 34, 35 that are arranged in an inflow disk 32 to spray discharge openings 7, and is discharged.

When the coil current is shut off and once the magnetic field has decayed sufficiently, armature 20 falls onto flange 21 from internal pole 13 as a result of the pressure of return spring 23, thereby moving valve needle 3 against the linear stroke direction. Valve closure element 4 thus settles onto valve seating surface 6, and fuel injection valve 1 is closed.

FIG. 2 shows a portion of a fuel injection valve 1 according to the present invention. Introduced into valve seat element 5 downstream from the valve seat is a passthrough opening 33 through which the fuel that is to be discharged flows, when fuel injection valve 1 is open, to an inflow disk 32 in which recesses 34, 35 form flow conduits through which the fuel can flow on to spray discharge openings 7. Inflow disk 32 is immobilized by positive joining in its position with respect to both valve seat element 5 and a perforated spray disk 31. Perforated spray disk 31 is joined to valve seat element 5, for example, by way of a weld join 36. Arranged in perforated spray disk 31 are multiple spray discharge openings 7 of which, for example, one spray discharge opening 7 is positioned on center axis 37 of fuel injection valve 1, and the remaining spray discharge openings 7 are distributed on two hole circles concentric with center axis 37 of fuel injection valve 1.

Inflow disk 32 is preferably embodied as a flat disk that is fabricated from a semiconductor substrate. The use of a silicon support (silicon wafer) is, in particular, conceivable. The radial extension of inflow disk 32 is smaller than the radial extension of perforated spray disk 31. Introduced into upstream side 38 of inflow disk 32 are recesses 34 which are embodied in the form of annular segments that extend concentrically with the hole circles of spray discharge openings 7. Each hole circle has a circular ring associated with it, the width and diameter of the circular rings being dimensioned such that in the radial direction there is substantially no overlap with spray discharge openings 7. The depth of recesses 34 is less than the thickness of inflow disk 32, and is determined by the thickness of inflow disk 32 minus the depth of recesses 35 (described below) of downstream side 39 of inflow disk 32.

Further recesses 35 embodied in annular shape are introduced into inflow disk 32 into the downstream side 39. The number of annular recesses 35 is identical to the number of hole circles on which spray discharge openings 7 are arranged. The width of downstream recesses 35 is greater than that of upstream recesses 34, and their diameters are such that the inlet openings of spray discharge openings 7 open out of annular recesses 35. The annular segments of upstream recesses 34 and the circular rings of downstream recesses 35 overlap in the radial direction; this results in a connection, through which fuel can flow, between passthrough opening 33 of valve seat element 5 and spray discharge openings 7.

A passthrough opening 40 is present in inflow disk 32 upstream from the centrally arranged spray discharge opening 7. For embodiments of fuel injection valve 1 having spray discharge openings 7 on a hole circle that are not intended to be switchable on and off, inflow disk 32 can also be equipped with simple passthrough openings upstream from spray discharge openings 7 that do not require switching.

Perforated spray disk 31 has a central recess 41 into which inflow disk 32 can be placed and whose depth corresponds to the thickness of inflow disk 32. An arrangement of inflow disk 32 in a recess to the side of valve seat element 5, for positive immobilization, is also conceivable. Spray discharge openings 7 of perforated spray disk 31 can be inclined with respect to center axis 37 of fuel injection valve 1, all spray discharge openings 7 arranged on a particular hole circle advantageously having an identical inclination. The opening angle of the conical surface on which center axes 42 of spray discharge openings 7 are located is greatest for the largest hole circle, so that the discharged fuel streams 48 do not interfere with one another's propagation.

In the direction of the upstream extension of center axes 42 of spray discharge openings 7, the various widths and radial extensions of recesses 34, 35 in inflow disk 32 result in formation of a surface 43 that, for example, is oriented approximately perpendicularly to center axes 42 of the respective spray discharge openings 7. Perforated spray disk 31 covers downstream recesses 35 of inflow disk 32, so that fuel flowing through inflow disk 32 is sharply deflected.

FIG. 3 depicts the arrangement of local heating elements 44 in a plan view of inflow disk 32. Local heating elements 44 are applied on surface 43 upstream from each switchable spray discharge opening 7, and are thus oriented in the downstream direction. In the exemplified embodiment depicted, all the local heating elements 44 that belong to the respective spray discharge openings 7 arranged on one hole circle are combined into one respective electrical circuit. Electrical supply leads 45a, 45b preferably extend radially outward on upstream side 38 of inflow disk 32 in the region between recesses 34. Contacting of electrical supply leads 45a, 45 (not depicted as they continue within fuel injection valve 1) can be accomplished, for example, in electrical plug contact 17. The combining of local heating elements 44 means that electrical supply leads 45a, 45b are routed on inflow disk 32 without intersection points. Local heating elements 44 are preferably applied onto inflow disk 32 using thin-film technology.

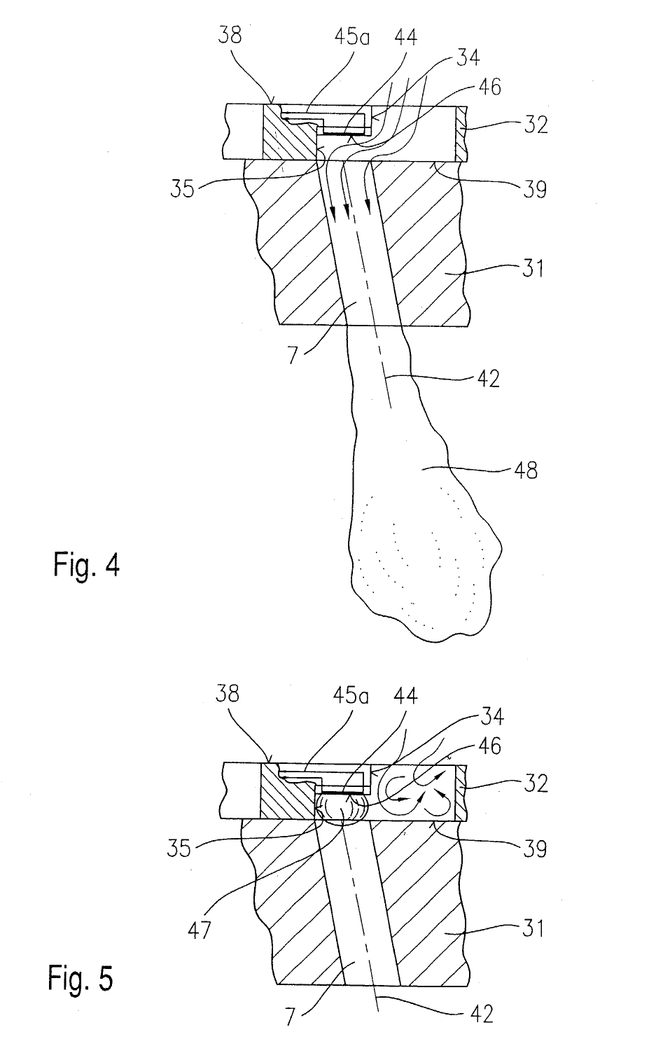

FIGS. 4 and 5 show detail IV of FIG. 2 in enlarged fashion, for better comprehension of the functioning of fuel injection valve 1 according to the present invention. When local heating element 44 is not energized, the fuel that flows into upstream recess 34 of inflow disk 32 when fuel injection valve 1 is open experiences a deflection, and flows along local heating element 44 to spray discharge opening 7 and is discharged.

If a spray discharge opening 7 is to be switched off, local heating element 44 is energized by way of an electrical current. Heating element 44 heats up sufficiently that local vaporization of fuel occurs on its downstream surface 46, as depicted in FIG. 5. As the volume of vaporized fuel increases, fuel vapor bubble 47 expands. Propagation occurs approximately spherically, proceeding from local heating element 44. Once fuel vapor bubble 47 is large enough, it blocks the entry of fuel into spray discharge opening 7 of perforated spray disk 31.

At the same time, any residual fuel still present in spray discharge opening 7 is pushed out of spray discharge opening 7 by the expanding fuel vapor bubble 47. After the residual fuel has been pushed out of spray discharge opening 7, no further fuel emerges from spray discharge opening 7.

The spray discharge pattern of fuel injection valve 1 is determined by the totality of fuel streams 48 that are discharged from the individual spray discharge openings 7. Deactivation of individual spray discharge openings 7 or groups of spray discharge openings 7 thus results in a modification of the overall spray discharge pattern. An individual stream characteristic is not influenced by the activation or deactivation of other spray discharge openings 7.

What is claimed is:

1. A fuel injection valve for fuel injection systems of internal combustion engines, having a valve needle (3) and a valve closure element (4), in working engagement therewith, that coacts with a valve seating surface (6) arranged in a valve seat element (5) to form a sealing seat, and having multiple spray discharge openings (7) downstream from the sealing seat, spray discharge of the fuel from at least one spray discharge opening (7) being capable of being switched off at least temporarily, wherein for switching off the spray discharge of fuel from a particular spray discharge opening (7) by local vaporization of fuel, a local heating element (44) is arranged in each case upstream of the respective spray discharge opening (7) on a surface (43) delimiting the flow path.

2. The fuel injection valve as defined in claim 1, wherein multiple local heating elements (44) are combined into one group that can be energized via a common circuit.

3. The fuel injection valve as defined in claim 1, wherein multiple local heating elements (44) are combined into multiple groups that can be energized separately from one another, each via a circuit.

4. The fuel injection valve as defined in one of claims 1 through 3, wherein the local heating elements (44) are applied on an inflow disk (32) upstream from a perforated spray disk (31) having the spray discharge openings (7).

5. The fuel injection valve as defined in claim 4, wherein the inflow disk (32) is immobilized in the fuel injection valve (1) by positive engagement.

6. The fuel injection valve as defined in one of claims 1 through 5, wherein the inflow disk (32) is fabricated from a semiconductor material.

7. The fuel injection valve as defined in claim 6, wherein the inflow disk (32) is a silicon support.

8. The fuel injection valve as defined in claim 6 or 7, wherein the local heating elements (44) are applied onto the inflow disk (32) using thin-film technology.
